(19) United States
(12) Patent Application Publication
(10) Pub. No.: US 2026/0026645 A1
(43) Pub. Date: Jan. 29, 2026

(54) COFFEE BREWING MECHANISM AND COFFEE MACHINE THEREOF

(71) Applicant: TSUN FOUN CORP., Changhua City (TW)

(72) Inventor: CHIH-SUNG KU, Changhua City (TW)

(73) Assignee: TSUN FOUN CORP., Changhua City (TW)

(21) Appl. No.: 18/786,624

(22) Filed: Jul. 29, 2024

(51) Int. Cl. A47J 31/36; A47J 31/06; A47J 31/08; A47J 31/44; F16C 11/04

(52) U.S. Cl. CPC A47J 31/3614; A47J 31/0663; A47J 31/0684; A47J 31/085; A47J 31/3652; A47J 31/4403; F16C 11/04

(57) ABSTRACT

A coffee brewing mechanism includes a brewing module having a swing arm, a pot and a driving assembly. The pot is connected to the swing arm and is operable to swing back and forth between an ascending position and a press-down position. The driver assembly includes a link rod and a driving member, wherein one end of the link rod is connected to the swing arm and the other end is provided with a follower. A cam is connected to the driving member, has a working curve and is in rolling contact with the follower. The working curve is formed by connecting a first arc and a second arc, and a radius of curvature of the first arc is greater than a radius of curvature of the second arc.

### BACKGROUND OF THE INVENTION

### 1. Field of the Invention

The present disclosure relates to a coffee brewing mechanism, and in particular to a coffee brewing mechanism and a coffee machine thereof.

### 2. Description of the Related Art

A conventional coffee machine, for example, a commercial coffee machine, can bet set according to different coffee drinking conditions and accordingly automatically brew coffee to meet customer requirements.

In a coffee brewing mechanism of the conventional coffee machine above, a pot can be closed while coffee is being brewed, for ground coffee and water to enter for brewing. The coffee brewing mechanism controls the movement of the pot by means of a cam in coordination with a follower, and a working curve of the cam is designed as an involute curve. Thus, when coffee is completely brewed and the pot is opened, the follower drops suddenly when the cam moves from a high point to a low point of the working curve, such that the pot can be quickly opened. However, due to the sudden drop, an impact is caused between the follower and the cam, resulting in an undesirable noise as well as susceptibility to damage of the cam and the follower due to such impact.

### BRIEF SUMMARY OF THE INVENTION

To overcome the issues above, the present disclosure provides a coffee brewing mechanism and a coffee machine thereof, which are free from an impact against a cam due to a sudden drop when a follower is guided by the cam during coffee brewing.

To achieve the object above, the present disclosure provides a coffee brewing mechanism adapted for a coffee machine to brew coffee. The coffee brewing mechanism includes a brewing module, which includes a swing arm, a pot and a driver assembly. The swing arm includes a first end and a second end, and is pivotally connected to a frame body of the coffee machine by the first end. The pot is connected to the second end and is operable to swing back and forth between an ascending position and a press-down position. The pot has an opening operable to cover a through hole of the frame body, wherein the through hole allows coffee liquid to pass through. The driver assembly includes a link rod and a driving member. One end of the link rod is connected to the swing arm and the other end is provided with a follower. The driving member is connected to a cam. The cam has a working curve and is in rolling contact with the follower, wherein the working curve formed by connecting a first arc and a second arc. The first arc has a first radius of curvature, and the second arc has a second radius of curvature, wherein the first radius of curvature of the first arc is greater than the second radius of curvature of the second arc. In one rotation cycle of the follower with the cam along the working curve, the follower is guided by the first arc to descend linearly to the press-down position, such that the link rod hauls the swing arm to drive the pot to swing from the ascending position to the press-down position. The follower further moves from the first arc to the second arc and is guided by the second arc, such that the link rod hauls the swing arm to keep the pot at the press-down position. Then, the follower moves from the second arc back to the first arc, and is guided by the first arc and ascends linearly to the ascending position.

In one embodiment, the first radius of curvature is 1.05 to 2 times the second radius of curvature.

In one embodiment, an upper dead center is defined at a central position of the first arc, a first lower dead center and a second lower dead center are defined on two ends where the first arc and the second arc intersect, a front section of the first arc is defined between the first lower dead center and the upper dead center, a rear section is defined between the upper dead center and the second lower dead center, and the front section and the rear section are left and right mirroring with respect to the upper dead center and have equal radiuses of curvature; the follower is guided by the working curve to first move from the upper dead center along the front section to the first lower dead center, such that the swing arm drives the pot to swing at a speed from the ascending position to the press-down position; the follower is further guided by the working curve to move from the first lower dead center along the second arc to the second lower dead center, such that the swing arm is kept still to keep the pot at the press-down position; the follower is then guided by the working curve to move from the second lower dead center along the rear section to the upper dead center, such that the swing arm drives the pot to swing at the speed from the press-down position back to the ascending position.

In one embodiment, the follower includes a slide block connected to one end of the link rod, the slide block is accommodated in a slide base of the frame body and is operable to slide linearly, the slide block includes an accommodating chamber, and the slide block includes a follower portion in the accommodating chamber; the driving member is a motor and is axially connected to the cam, and the cam is accommodated in the accommodating chamber and is kept in the rolling contact with the follower portion by the working curve.

In one embodiment, a drawing module is further included. The drawing module includes a cylinder, a piston, a crank and a second driving member. The cylinder is vertically fixed at the frame body, and is located on a side opposite to the pot and covers the through hole. The piston is disposed in the cylinder and is operable to move linearly along the cylinder to become close to or become away from the through hole. One end of the crank is pivotally connected to the piston. The second driving member is connected to one end of the crank away from the piston, and drives the crank to drive the piston to move linearly within the cylinder. When the pot covers the through hole by the opening in a sealed manner to brew the coffee, the second driving member drives via the crank the piston to move linearly along the cylinder, so as to perform vacuum suction within the pot and suck the brewed coffee through the through hole and into the cylinder.

In one embodiment, a filter replacement module is further included. The filter replacement module is disposed at the frame body and is located next to the coffee brewing mechanism. The filter replacement module replaces filter paper for filtering the coffee at the through hole after the coffee brewing mechanism brews the coffee.

In one embodiment, the filter replacement module includes a roller, a press rod and a third driving member. The roller is rotatably disposed at the frame body, and filter paper for brewing the coffee passes through the through hole and passes by the roller. The press rod normally presses the filter paper on the roller. The third driving member is connected to and drives the roller, and the third driving member drives the roller to rotate when the pot swings with the swing arm to the ascending position after coffee brewing is completed, so as to drag the filter paper to wind and be replaced.

In one embodiment, the press rod is provided with a roller wheel, and the filter paper is normally pressed on the roller by the roller wheel.

In one embodiment, the frame body includes a horizontal portion and a vertical portion, the through hole is disposed at the horizontal portion, the brewing module is disposed above the horizontal portion, the drawing module is disposed below the horizontal portion, and the filter replacement module is disposed on a lateral side of the horizontal portion and is located next to the brewing module.

The present disclosure further provides a coffee machine including the coffee brewing mechanism above.

Thus, in the coffee brewing mechanism and the coffee machine thereof, the working curve of the cam of the brewing module is formed by connecting the first arc and the second arc. When the follower rotates with the cam and moves from the second arc back to the first arc such that the swing arm is hauled by the link rod and swings from the press-down position back to the ascending position, with the radius of curvature of the first arc that is greater than the radius of curvature of the second arc, the follower is enabled to moderately and smoothly move from the second arc back to the first arc, and thus the follower is free from any concern of dropping suddenly or impact against the cam. Therefore, no undesirable noise is produced during the process of coffee brewing, and the follower and the cam likewise do not become damaged due to impact.

### BRIEF DESCRIPTION OF THE DRAWINGS

FIG. 1 is a perspective appearance diagram of a coffee brewing mechanism according to an embodiment of the present disclosure.

FIG. 2 is a perspective appearance diagram of the coffee brewing mechanism in FIG. 1 from another angle of view.

FIG. 3 is a perspective appearance diagram of a support panel and a through hole that are seen when a pot is opened in the coffee brewing mechanism in FIG. 2.

FIG. 4 is a perspective appearance diagram of the coffee brewing mechanism FIG. 1 from yet another angle of view.

FIG. 5 is an exploded configuration diagram of a driver assembly of a brewing module according to an embodiment of the present disclosure.

FIG. 6A is a schematic diagram of a cam driving a link rod according to an embodiment of the present disclosure, wherein the cam is in contact with a follower portion by a first arc, and the link rod and a slide block at this point are at upper positions relative to a slide base.

FIG. 6B is another schematic diagram of a cam driving a link rod according to an embodiment of the present disclosure, wherein the cam is in contact with a follower portion by a second arc, and the link rod and a slide block at this point are at lower positions relative to a slide base.

FIG. 7 is a section diagram along the section line 7-7 in FIG. 2, wherein a pot is located at a press-down position.

FIG. 8 is a section diagram of the pot in FIG. 7 moving to an ascending position.

FIG. 9A is a schematic diagram of a follower in contact with a working curve of a cam, wherein the cam is in contact with the follower by an upper dead center of the first arc.

FIG. 9B shows the cam in FIG. 9A rotating counterclockwise to a first lower dead center to be in contact with a follower, and the follower at this point moves downward such that a pot corresponds to a press-down position.

FIG. 9C shows the cam in FIG. 9B further rotating counterclockwise to a second arc so as to be in contact with the follower, and the follower at this point is located at an original position such that the pot is kept at the press-down position.

FIG. 9D shows the cam in FIG. 9C further rotating counterclockwise, wherein the follower crosses over the second dead pint and is in contact with the first arc, and the follower at this point moves upward to the position in FIG. 9A such that the pot corresponds to an ascending position.

FIG. 10 is a perspective appearance diagram of a coffee machine applying a coffee brewing mechanism according to an embodiment of the present disclosure.

### DETAILED DESCRIPTION OF THE INVENTION

To fully understand the present disclosure, the present disclosure is described in detail by way the specific embodiments with the accompanying drawings below. A person skilled in the art would be able to understand the objects, features and effects of the present disclosure from the disclosure of the present application. It should be noted that, the disclosure may be implemented or applied by other specific embodiments, and changes and modifications may also be made on the basis of different perspectives and applications to various details in the description without departing from the spirit of the present disclosure. Technical contents associated with the present disclosure are described in detail below, and it should be noted that the disclosure is not to be construed as limitations to the scope of protection of the present disclosure. Associated details are as given in the description below.

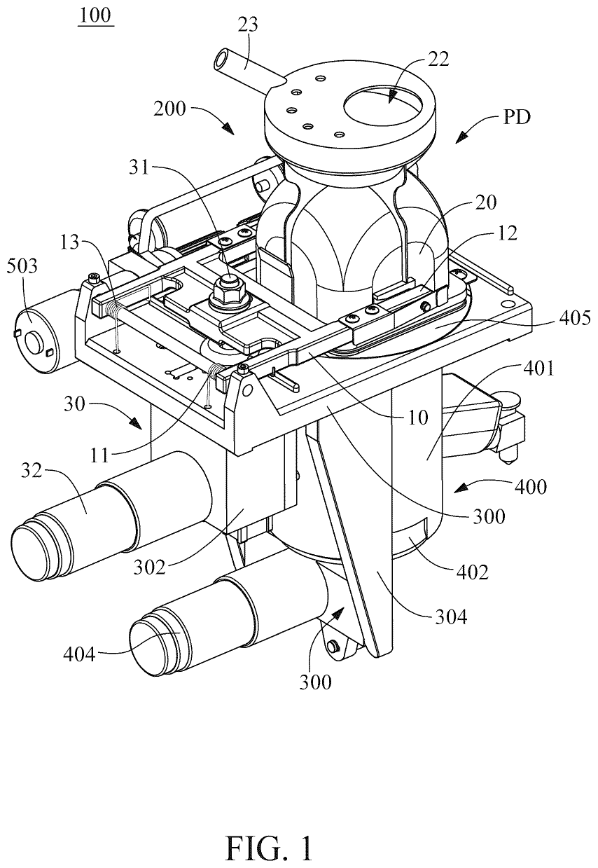

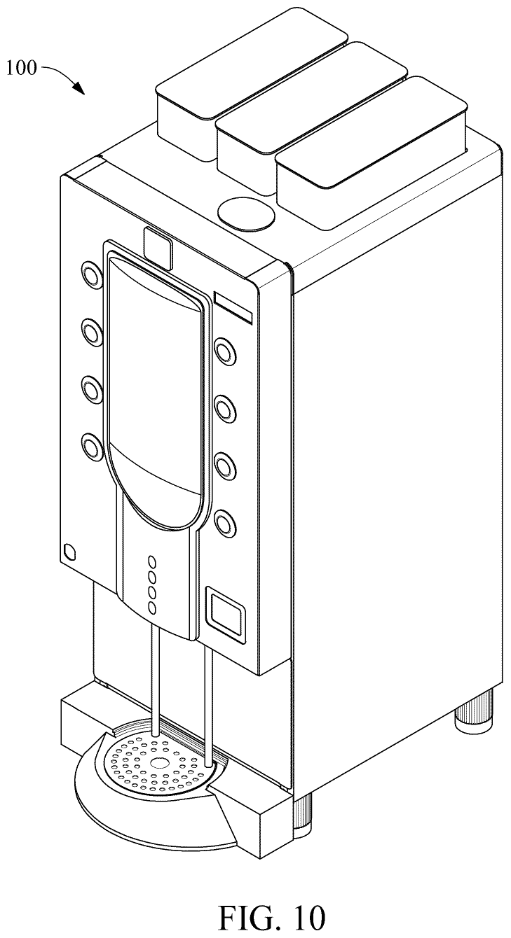

As shown in FIG. 1 to FIG. 9D, the present disclosure provides a coffee brewing mechanism adapted to be installed in a coffee machine 100 (as shown in FIG. 10), so as to brew coffee. As shown in FIG. 1, the coffee brewing mechanism primarily includes a brewing module 200 disposed at a frame body 300, and in one embodiment, further includes a drawing module 400 and a filter replacement module 500 similarly disposed at the frame body 300, with details of specific embodiments to be described below.

As shown in FIG. 1, the brewing module 200 includes a swing arm 10, a pot 20 and a driver assembly 30. The swing 10 includes a first end 11 and a second end 12, and is pivotally connected to the frame body 300 of the coffee machine 100 by the first end 11. In one embodiment, the swing arm 10 is provided with a reset spring 13 (referring to FIG. 1) between the first end 11 and the frame body 300, wherein the reset spring 13 drives the swing arm 10 to swing normally in an upward direction.

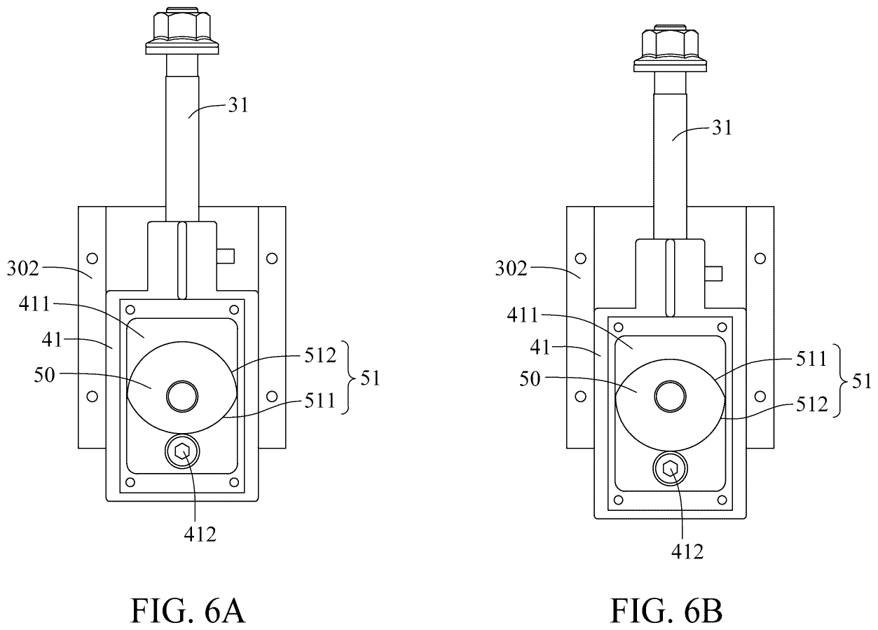

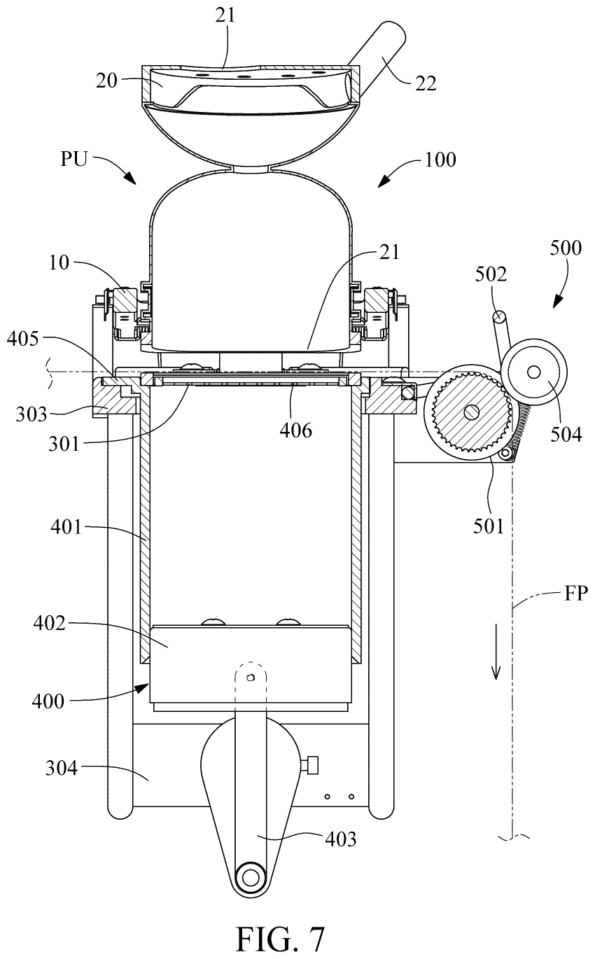

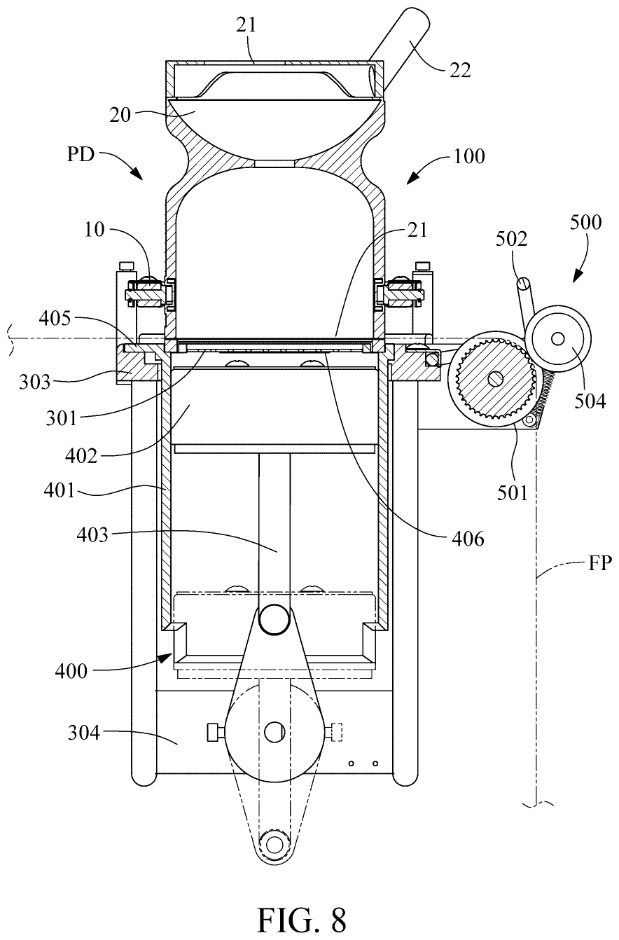

The pot 20 is connected to the second end 12 of the swing arm 10, and can thus swing back and forth between an ascending position PU (referring to FIG. 7) and a press-down position PD (referring to FIG. 8) along with the swing arm 10 (referring to FIG. 6A). As shown in FIG. 7, the pot 20 has an opening 21, and can cover a through hole 301 of the frame body 300 by means of the opening 21, wherein the through hole 301 is for coffee liquid to pass through. In one embodiment, the pot 20 has a feed portion 22 and a water inlet portion 23, so as to allow ground coffee and water to respectively enter the pot 20 via the feed portion 22 and the water inlet portion 23 for coffee brewing.

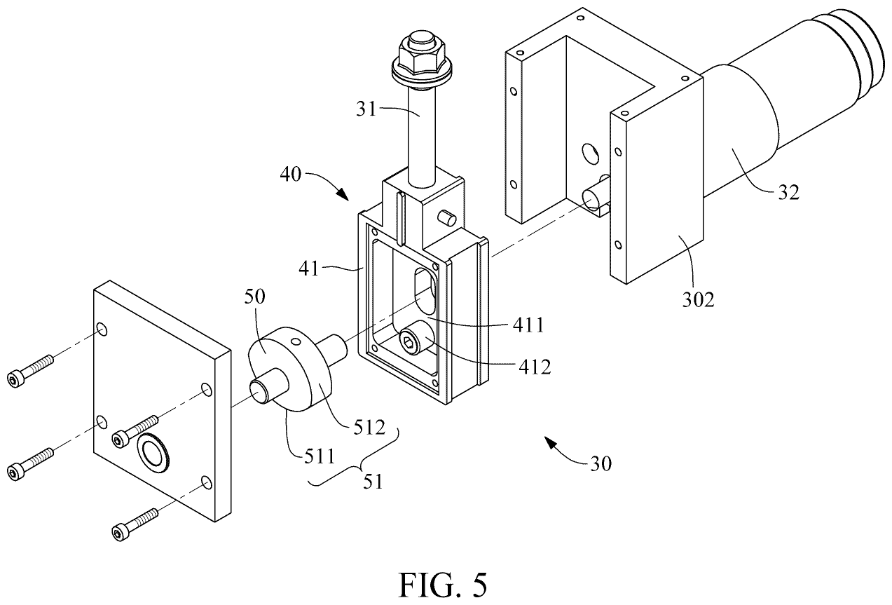

As shown in FIG. 5, the driver assembly 30 includes a link rod 31 and a driving member 32. One end of the link rod 31 is connected to the swing arm 10 (referring to FIG. 1), and the other end is provided with a follower 40. The driving member 32 is connected to a cam 50 which has a working curve 51. The follower 40 is in roller contact on the working curve 51, and the working curve 51 guides the follower 40 to move linearly back and forth.

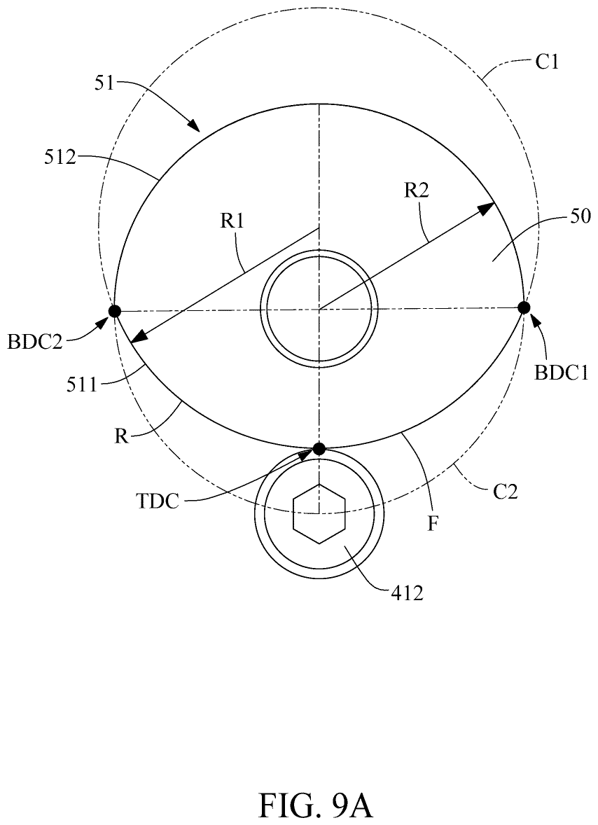

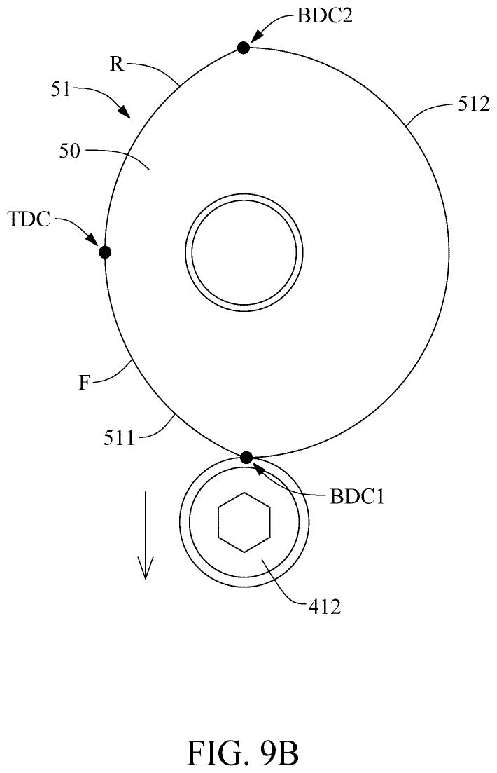

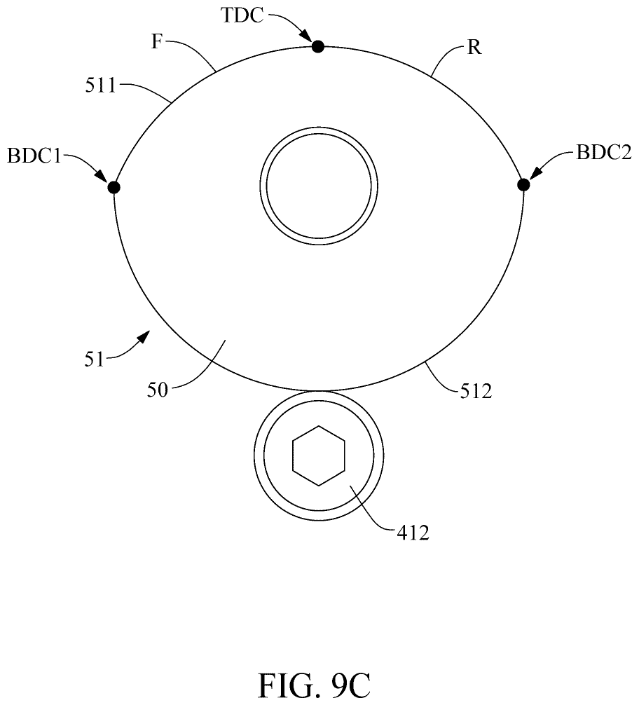

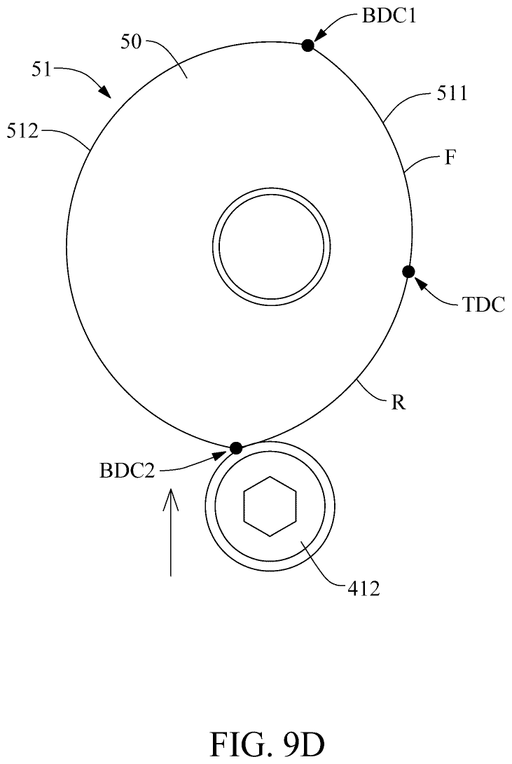

As shown in FIG. 5, FIG. 6A and FIG. 6B, the working curve 51 is formed by connecting a first arc 511 and a second arc 512. As shown in FIG. 9A, the first arc 511 has a first radius of curvature R1 (also referring to an imaginary circle C1 of the first radius of curvature R1), and the second arc 512 has a second radius of curvature R2 (also referring to an imaginary circle C2 of the second radius of curvature C2), wherein the first radius of curvature C1 is greater than the second radius of curvature R2. In one embodiment, the first radius of curvature C1 is 1.05 or 2 times the second radius of curvature R2. Regarding the first arc 511 and the second arc 512 shown in FIG. 9A, the first radius of curvature C1 is 1.08 times the second radius of curvature R2. Accordingly, when the follower 40 rotates one cycle with the cam 50 along the working curve 51, for example, the cam 50 rotates clockwise, the follower 40 at this point is guided from the first arc 511 and moves linearly downward to the press-down position PD (as the movement from FIG. 9A to FIG. 9B), such that the link rod 31 hauls the swing arm 10 to drive the pot 20 to swing from the ascending position PU to the press-down position PD. The follower 40 further moves from the first arc 511 to the second arc 512, and is guided by the second arc 512 such that the link rod 31 hauls the swing arm 10 to keep the pot 20 at the press-down position PD (as shown in FIG. 9C). Then, the follower 40 returns from the second arc 512 to the first arc 511 (as shown in FIG. 9D), and is guided by the first arc 511 to move linearly upward to the ascending position PU, thereby completing one cycle of movement of the follower 40 guided by the working curve 51.

In one embodiment, as shown in FIG. 9A to FIG. 9D, an upper dead center TDC is defined at a central position of the first arc 511, a first lower dead center BCD1 and a second lower dead center BCD2 are respectively defined on two ends where the first arc 511 and the second arc 512 intersect, and the first arc 511 is defined with a front section F between the upper dead center TDC and the first lower dead center BDC1 and is defined with a rear section R between the second lower dead center BDC2 and the upper dead center TDC, wherein the front section F and the rear section R are left and right mirroring with respect to the upper dead center TDC and have equal radiuses of curvature. Accordingly, when the cam 50 rotates one cycle, the follower 40 is guided by the working curve 51 to first move at a speed from the upper dead center TDC along the front section F to the first lower dead center BDC1, such that the swing arm 10 drives the pot 20 to swing from the ascending position PU to the press-down position PD. Then, the follower 40 is guided by the working curve 51 to move from the first lower dead center BDC1 along the second arc 512 to the second lower dead center BDC2, such that the swing arm 10 is maintained still to keep the pot 20 at the press-down position PD. Next, the follower 40 is further guided by the working curve 51 to move at the speed from the second lower dead center BDC2 along the rear section R to the upper dead center TDC, such that the swing arm 10 drives the pot 20 to swing from the press-down position PD back to the ascending position PU. Since the front section F and the rear section R of the first arc 511 with respect to the upper dead center TDC are left and right mirroring and have equal radiuses of curvature, the speed at which the follower 40 guided by the working curve 51 moves from the second lower dead center BDC2 along the rear section R to the upper dead center TDC is equal to the speed by which the follower 40 guided by the working curve 51 moves from the second lower dead center BDC2 along the rear section R to the upper dead center TDC are the same.

In one embodiment, as shown in FIG. 5, the follower 40 includes a slide block 41 connected to one end of the link rod 31. The slide block 41 is accommodated in a slide base 302 of the frame body 300, and can thus slide linearly in the slide base 302. The slide block 41 has an accommodating chamber 411, and includes a follower portion 412 in the accommodating chamber 411, wherein the follower portion 412 is a roller wheel in one embodiment. Moreover, the driving member 32 is a motor and is axially connected to the cam 50. At this point, the cam 50 is accommodated in the accommodating chamber 411, and is kept in rolling contact with the follower portion 412 by the working curve 51. In one embodiment, rolling contact of the working curve 51 and the follower portion 412 with each other is caused by the reset spring 13 driving the swing arm 10 to swing normally in an upward direction.

It is seen from the description above that, compared to a working curve of a cam of a conventional coffee brewing mechanism that is designed as a involute curve, in the coffee brewing mechanism of the present disclosure, the working curve 51 of the cam 50 is formed by connecting the first arc 511 and the second arc 512, and the first radius of curvature R1 of the first arc 511 is greater than the second radius of curvature R2 of the second arc 512. Thus, when the follower 40 rotates with the cam 50 along the second arc 512 to move back to the first arc 511 such that the link rod 50 hauls the swing arm 10 to drive the pot 20 to swing from the press-down position PD back to the ascending position PU, the follower 40 can moderately and smoothly move from the second arc 512 back to the first arc 511, and the follower 40 is free from any concern of dropping suddenly or impact against the cam 50. Therefore, no undesirable noise is produced during the process of coffee brewing, and the follower 40 and the cam 50 likewise do not become damaged due to impact.

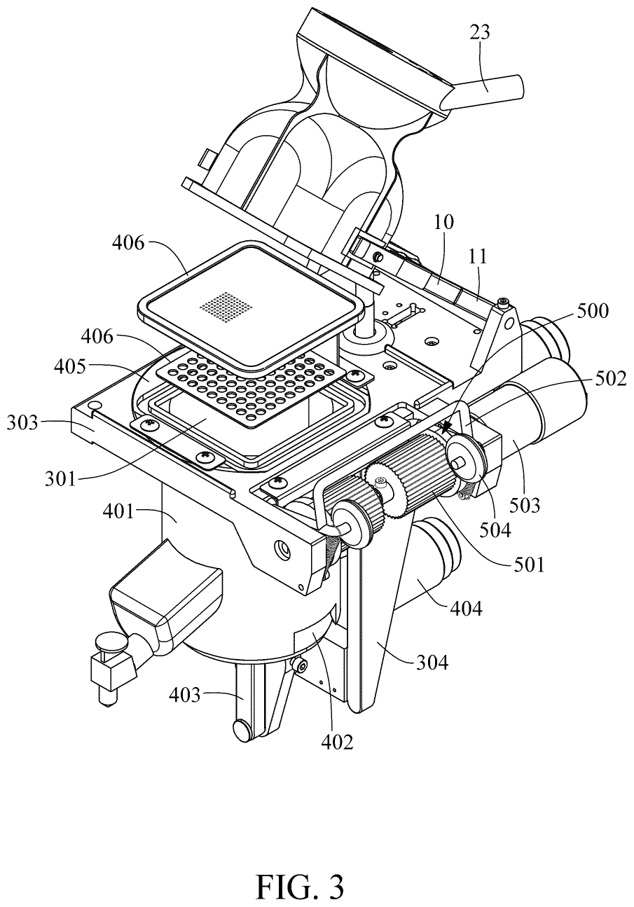

In one embodiment, the frame body 300 includes a horizontal portion 303 and a vertical portion 304. The through hole 301 is disposed at the horizontal portion 303 (referring to FIG. 3). The brewing module 200 is disposed above the horizontal portion 303, the drawing module 400 is disposed below the horizontal portion 303, and the filter replacement module 500 is disposed on a lateral side of the horizontal portion 303 and is located next to the brewing module 200.

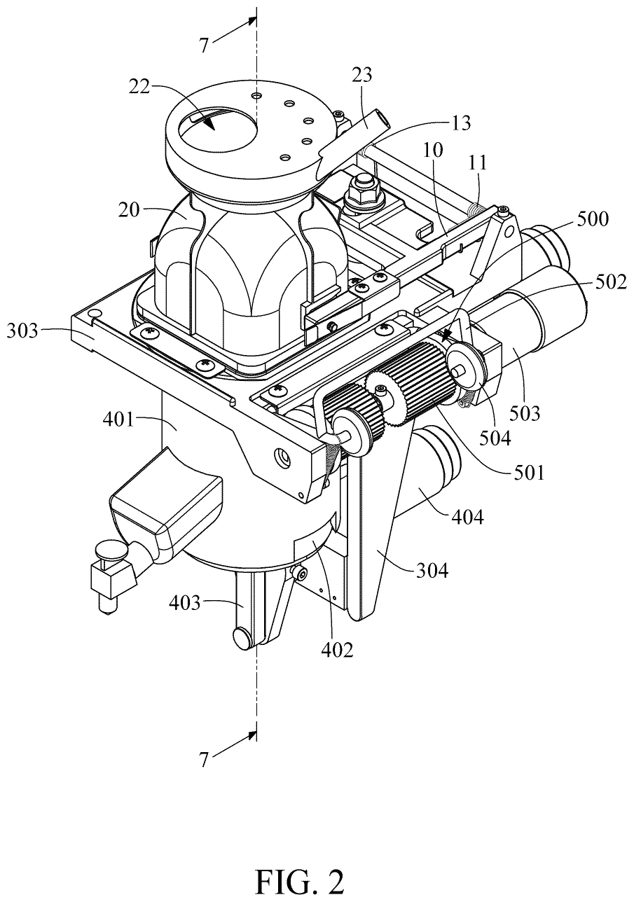

As shown in FIG. 2, FIG. 7 and FIG. 8, the drawing module 400 includes a cylinder 401, a piston 402, a crank 403 and a second driving member 404. In one embodiment, the cylinder 401 is vertically fixed at the frame body 300, and is located below the horizontal portion 303 and on a side opposite to the pot 20 located above the horizontal portion 303. The cylinder 401 has a flange 405 fixed at the horizontal portion 303. One end of the cylinder 401 at the flange 405 is hollow and accordingly forms the through hole 301, and the pot 20 covers the flange 405 at the press-down position PD, such that the opening 21 and the through hole 301 are in communication. At this point, a sealed space is formed between the pot 20 and the cylinder 401. Moreover, the drawing module 400 can be provided with a support panel 406 on one end of the flange 405, and filter paper FP can be disposed at the support panel 406 during coffee brewing. The support panel 405 has pores for allowing liquid to flow into the cylinder 401 from the pot 20.

The piston 402 is disposed in the cylinder 401 and can move linearly along the cylinder 401. The piston 402 can ascend within the cylinder 401 to become close to the through hole 301, or descend within the cylinder 401 to become away from the through hole 301. As shown in FIG. 7 and FIG. 8, one end of the crank 403 is pivotally connected to the piston 402, and the other end of the crank 403 is connected to the second driving member 404. The second driving member 404 is operable to drive the crank 403 to swing, and to drive the piston 402 to move linearly within the cylinder 401 (as shown in FIG. 8), and to perform vacuum suction within the pot 20.

Thus, during coffee brewing of the coffee machine 100, the filter paper FP can be disposed at the position of the through hole 301 and be support by the support panel 406, and the pot 20 moves to the press-down position PD, covers the through hole 301 in a sealed manner by the opening 21 and is in communication with the cylinder 401. Thus, ground coffee and water can respectively enter the pot 20 via the feed portion 22 and the water inlet portion 23 for coffee brewing. Once coffee brewing is completed, the piston 402 is driven by the second driving member 404 via the crank 403, such that the piston 402 within the cylinder 401 descends from the position close to the through hole 301 and becomes away from the through hole 301. At this point, a negative pressure is formed within the cylinder 401 due to the descending of the piston 402 generate vacuum suction within the pot 20, so that coffee liquid within the pot 20 is forced through the filter paper FP and the pores of the support panel 406, and is drawn to the cylinder 401, and the used ground coffee after coffee brewing can be blocked by the filter paper FP. At this point, the coffee within the cylinder 401 can be taken out for drinking.

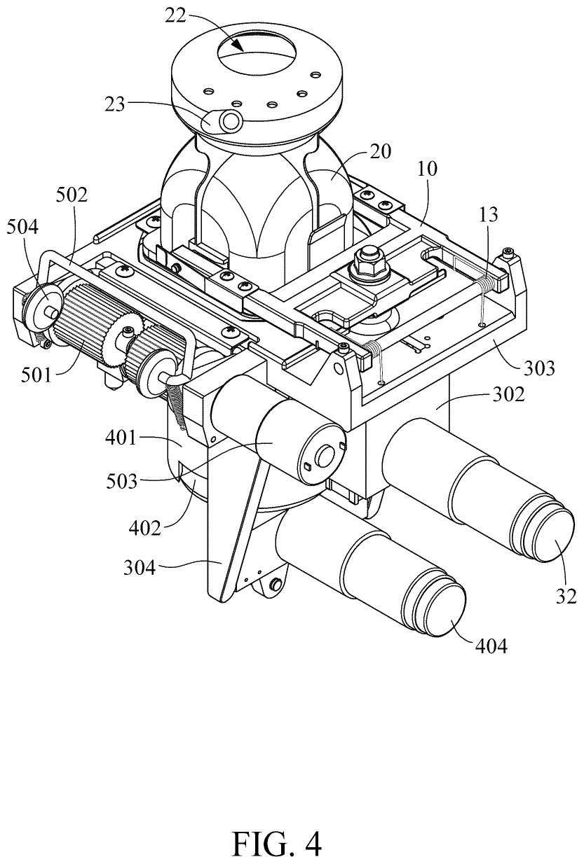

In one embodiment, as shown in FIG. 3 and FIG. 4, the filter replacement module 500 includes a roller 501, a press rod 502 and a third driving member 503. The roller 501 can be rotatably disposed at the frame body 300, and the filter paper FP in one embodiment passes through the through hole 301 and passes by the roller 501. Moreover, the press rod 502 is provided with a roller wheel 504, and the filter paper FP is normally pressed on the roller 501 by the roller wheel 504. The third driving member 503 is connected to and drives the roller 501. When the pot 20 swings with the swing arm 10 to the ascending position PU after coffee brewing is completed, the third driving member 503 can drive the roller 501 to rotate, so as to drag the filter paper FP to wind and thus automatically replace the filter paper FP.

In one embodiment, the driving member 32, the second driving member 404 and the third driving member 503 are three power sources independent from one another, and can each be an electric motor (for example but not limited to, a step motor or a servo motor) of which a rotating speed can be controlled by a controller (not shown). The swing arm 10 of the brewing module 200 is independently driven by the driving member 32, the piston 402 of the drawing module 400 is independently driven by the second driving member 404, and the roller 501 of the filter replacement module 500 is driven independently by the third driving member 503. By controlling operating timings of the driving member 32, the second driving member 404 and the third driving member 503 using signals by the controller according to a program, linked operations of the brewing module 200, the drawing module 400 and the filter replacement module 503 can be performed according to a coffee brewing procedure, so that the brewing module 200, the drawing module 400 and the filter replacement module 503 can be better modularized to improve assembly and maintenance efficiency of the coffee machine 100.

In addition, in the coffee brewing mechanism of the present disclosure, the pot 20 is designed to have a sufficient volume, so that ground coffee and water added into the pot 20 and mixed into coffee liquid do not overflow from the feed portion 22 or the water inlet portion 23 during the brewing process. Moreover, after coffee brewing is completed, the water inlet portion 23 of the coffee brewing mechanism of the present disclosure can coordinate with incoming water to clean the pot 20, preventing used ground coffee from remaining on inner walls of the pot 20 and thus maintaining cleanliness.

The present invention is described by way of the preferred embodiments above. A person skilled in the art should understand that, these embodiments are merely for describing the present invention are not to be construed as limitations to the scope of the present invention. It should be noted that all equivalent changes, replacements and substitutions made to the embodiments are to be encompassed within the scope of the present invention. Therefore, the scope of protection of the present invention should be accorded with the broadest interpretation of the appended claims.

What is claimed is:

1. A coffee brewing mechanism, adapted for a coffee machine to brew coffee, the coffee brewing mechanism comprising:
a brewing module, comprising:
a swing arm, comprising a first end and a second end, the swing arm pivotally connected to a frame body of a coffee machine by the first end;
a pot, connected to the second end and operable to swing back and forth with the swing arm between an ascending position and a press-down position, the pot having an opening operable to cover a through hole of the frame body, the through hole for allowing coffee liquid to pass through; and
a driver assembly, comprising a link rod and a driving member, one end of the link rod connected to the swing arm and one other end provided with a follower, the driver assembly connected to a cam and operable to drive the cam to rotate, the cam having a working curve and being in rolling contact with the follower, the working curve formed by connecting a first arc and a second arc, the first arc having a first radius of curvature, the second arc having a second radius of curvature, the first radius of curvature of the first arc being greater than the second radius of curvature of the second arc;
wherein, in one rotation cycle of the follower with the cam along the working curve, the follower is guided by the first arc to move linearly downward to the press-down position, such that the link rod hauls the swing arm to drive the pot to swing from the ascending position to the press-down position, the follower then moves from the first arc to the second arc and is guided by the second arc such that the link rod hauls the swing arm to keep the pot at the press-down position, and the follower then again moves from the second arc back to the first arch and is guided by the first arc to move linearly upward to the ascending position.

2. The coffee brewing mechanism according to claim 1, wherein the first radius of curvature is 1.05 to 2 times the second radius of curvature.

3. The coffee brewing mechanism according to claim 1, wherein an upper dead center is defined at a central position of the first arc, a first lower dead center and a second lower dead center are defined on two ends where the first arc and the second arc intersect, a front section of the first arc is defined between the first lower dead center and the upper dead center, a rear section is defined between the upper dead center and the second lower dead center, and the front section and the rear section are left and right mirroring with respect to the upper dead center and have equal radiuses of curvature; the follower is guided by the working curve to first move from the upper dead center along the front section to the first lower dead center, such that the swing arm drives the pot to swing from the ascending position to the press-down position; the follower is further guided by the working curve to move from the first lower dead center along the second arc to the second lower dead center, such that the swing arm is maintained still to keep the pot at the press-down position; the follower is further guided by the working curve to move from the second lower dead center along the rear section to the upper dead center, such that the swing arm drives the pot to swing from the press-down position back to the ascending position.

4. The coffee brewing mechanism according to claim 1, wherein the follower comprises a slide block connected to one end of the link rod, the slide block is accommodated in a slide base of the frame body and is operable to slide linearly, the slide block comprises an accommodating chamber, and the slide block comprises a follower portion in the accommodating chamber; the driving member is a motor and is axially connected to the cam, and the cam is accommodated in the accommodating chamber and is kept in the rolling contact with the follower portion by the working curve.

5. The coffee brewing mechanism according to claim 1, further comprising:
a drawing module, comprising:
a cylinder, vertically fixed at the frame body, and located on a side opposite to the pot and covering the through hole;
a piston, disposed in the cylinder and operable to move linearly along the cylinder to become close to or become away from the through hole;
a crank, having one end pivotally connected to the piston; and
a second driving member, connected to one end of the crank away from the piston and driving the crank to drive the piston to move linearly within the cylinder;
wherein when the pot covers the through hole by the opening in a sealed manner to brew the coffee, the second driving member drives via the crank the piston to move linearly along the cylinder, so as to perform vacuum suction within the cylinder and sucking the brewed coffee through the through hole and into the cylinder.

6. The coffee brewing mechanism according to claim 1, further comprising:
a filter replacement module, disposed at the frame body and located next to the coffee brewing mechanism, the filter replacement module replacing filter paper for filtering the coffee at the through hole after the coffee brewing mechanism brews the coffee.

7. The coffee brewing mechanism according to claim 6, wherein the filter replacement module further comprises:
a roller, rotatably disposed at the frame body, wherein the filter paper for brewing the coffee passes through the through hole and passes by the roller;
a press rod, provided with a roller wheel normally pressing the filter paper on the roller; and
a third driving member, connected to and driving the roller, the third driving member drives the roller to rotate when the pot swings with the swing arm to the ascending position after coffee brewing is completed, so as to drag the filter paper to wind and be replaced.

8. The coffee brewing mechanism according to claim 7, wherein the frame body comprises a horizontal portion and a vertical portion, the through hole is disposed at the horizontal portion, the brewing module is disposed above the horizontal portion, the drawing module is disposed below the horizontal portion, and the filter replacement module is disposed on a lateral side of the horizontal portion and is located next to the brewing module.

9. A coffee machine, comprising the coffee brewing mechanism according to claim 1.
